(19) United States
(12) Patent Application Publication
(10) Pub. No.: US 2012/0171417 A1
(43) Pub. Date: Jul. 5, 2012

(54) MULTI-FUNCTIONAL POLYESTER FILMS AND A METHOD FOR MANUFACTURING THE SAME

(75) Inventors: Wen-Hsiung LEE, Taipei City (TW); Jui-Chang HSU, Taipei City (TW); Wen-Hsiang HSU, Taipei City (TW); Chia-Ping CHU, Taipei City (TW)

(73) Assignee: SHINKONG MATERIALS TECHNOLOGY CORPORATION, Taipei City (TW)

(21) Appl. No.: 13/334,681

(22) Filed: Dec. 22, 2011

(30) Foreign Application Priority Data
Dec. 31, 2010 (TW) 099147264

(51) Int. Cl. B32B 3/00; B29C 47/04; C08L 67/03; B29C 47/88

(52) U.S. Cl. 428/141; 264/210.1; 264/173.16; 525/165; 524/605

(57) ABSTRACT

The present invention relates to a method for producing a multi-function polyester film by monolayer extrusion or multilayer extrusion, comprising providing at least one polyester material and at least one polyester material having diffusion particles; melt extruding and then cooling the polyester material rapidly to form a polyester sheet; treating the polyester sheet with biaxially orientation and then cooling the polyester sheet to obtain the polyester film. The method of the present invention provides the multi-function polyester film with a haze value below 95%, and a surface roughness value (Ra) above 0.1 nm.

### BACKGROUND

1. Technical Field of the Invention

The present invention relates to a method for producing a multi-functional polyester film, particularly a method for producing a biaxially orientated polyester film with high surface roughness, good diffusion effect and excellent adhesion by co-extrusion.

2. Description of Related Art

A backlight module is one of key elements in the liquid crystal display. Since a liquid crystal molecule itself cannot emit light, the function of the backlight module is to provide a light source with sufficient brightness and uniform distribution. The backlight module comprises a light source such as a cold cathode fluorescent lamp (CCFL) or a light emitting diode (LED), a lampshade, a reflecting plate, a light guide plate, a diffusion plate and an optical film such as a diffusion film and a brightness enhancement film, wherein the optical film is the main technology and contributes to the majority of costs of the backlight module. While the manufacture technology of the liquid crystal display is improved, the backlight module has to achieve the requirements, such as thin structure, high brightness and low cost in addition to the trends of large size and low price. Thus, the development and the design of a novel backlight module are the current issues to be solved nowadays. Besides, in order to obtain uniform light and to achieve the increased availability of light, a backlight module usually uses a brightness enhancement film in combination with a diffusion film. A common substrate of the brightness enhancement film and the diffusion film is a transparent polyester film with low haze, high transparency, good adhesion and weather resistance.

The biaxially orientated polyester film can be used as a substrate of the optical film due to good mechanical properties and dimensional stability thereof. Further, it has to meet extremely high cleanliness (e.g. foreign body contamination) and low defect (e.g. scratch) requirements and the like. Therefore, in order to solve the scratch problem, organic or inorganic particles can be added by a internal addition to the surface of the film or the slippery property of the polyester film itself is increased by coating in addition to high quality of raw materials and good working environment. However, the addition of the particles can affect the transparency of a polyester film, and different types, sizes and quantities of particles added also affect the transparency to different extent.

Due to extremely high requirements, the cost of an optical film contributes to the main part of that of the backlight module. Therefore, if a diffusion film and a brightness enhancement film can be integrated, the cost burden of the backlight module will be reduced. Further, the integrated composite film having diffusion and brightness enhancement effects is a future trend. The increase in the functionality of a substrate is also expectable in the future.

The current method for producing the integrated composite film achieves the diffusion effect by coating the surface of an article with diffusion particles. However, this method has many processing procedures and thus, not only the manufacturing cost increases, but also the processing losses will result in the lost of the yield of the product. Accordingly, the current method for producing a integrated composite film needs further improvement.

### SUMMARY

In view that the current method for producing a composite film with a diffusion effect is complex and the cost cannot be reduced, the inventors of the present application finally invent a method for producing a multi-functional polyester film after the long time researches and the large amounts of tests.

The object of the present invention is to provide a method for producing a biaxially orientated polyester film with high surface roughness, good diffusion effect and excellent adhesion by melt extrusion.

In order to achieve the forgoing object, a method for producing a polyester film according to the present invention comprises:
providing at least one polyester raw material and adding diffusion particles into at least one polyester raw material;
melt-extruding the raw material, followed by rapid cooling to form a polyester sheet;
biaxially orientating the polyester sheet, followed by cooling to form a polyester film.

Preferably, the obtained polyester film has a total thickness of 20 μm˜500 μm, a surface roughness value (Ra) above 0.1 nm, a haze value below 95%, and a transmittance above 60%.

Preferably, in the step of providing at least one polyester raw material, the polyester raw material is selected from the group consisting of poly(ethylene terephthalate) (PET), acrylic, polycarbonate, poly(ethylene naphthalate) (PEN) and the combinations and the copolymers thereof.

Preferably, in the step of providing at least one polyester raw material, the diffusion particles are at least added to the external surface of polyester.

Preferably, in the step of melt-extruding the polyester raw material, the polyester raw material is melt-extruded at a temperature between 260° C. and 300° C. and then rapidly cooled to 25° C. to 50° C.

Preferably, the diffusion particles are selected from the group consisting of polymethyl methylacrylate (PMMA), silica, silicone, polystyrene (PS), melamine, barium sulphate, calcium carbonate, titanium oxide, zirconium oxide, aluminum oxide, silica gel and the combinations thereof.

The diffusion particles have an average particle diameter of about 0.1 μm∞15 μm, preferably about 18 10 μm, more preferably about 3˜6 μm.

The diffusion particles are added in an amount of 0.01˜10 wt %, preferably 0.02˜5 wt %, more preferably 0.03˜3 wt %, based on the amount of the polyester raw material.

Preferably, the diffusion particles are in a spherical, a grape-like, a hollow spherical or a polygonal shape, most preferably a spherical shape.

The particle diameter distribution of the diffusion particle is in the single-or multi-distribution pattern, preferably in the single distribution pattern.

The step of providing at least one polyester raw material further comprises adding an additive into the at least one polyester raw material, wherein the additive is selected from the group consisting of UV-resistant modifiers, weather-resistant modifiers, hydrolysis-resistant modifiers, thermal-resistant modifiers, slippery property modifiers, crystallinity modifiers, comonomers and the combinations thereof.

In an embodiment, the step of providing at least one polyester raw material comprises providing a single polyester raw material and forming a single polyester film by monolayer melt-extrusion.

In another embodiment, the step of providing at least one polyester raw material comprises providing first polyester raw material and second polyester raw material, and forming a double layer polyester film comprising the first polyester layer and the second polyester layer by double-layer melt-extrusion.

The double-layer polyester film has a thickness ratio of 1∥100:1.

In a further embodiment, the step of providing at least one polyester raw material comprises providing first surface layer polyester raw material, interior layer polyester raw material and second surface layer polyester raw material, and forming a multilayer polyester film comprising first and second surface polyester layers and an interior polyester layer formed between the said first and second surface polyester layer by multilayer melt-extrusion.

In one embodiment, the composition of the first surface layer polyester raw material is identical to that of the second surface layer polyester raw material and different from that of the interior layer polyester raw material.

In another embodiment, the composition of the first surface layer polyester raw material is identical to that of the interior layer polyester raw material and different from that of the second surface layer polyester raw material.

In a further embodiment, the compositions of the first surface layer, the interior layer and the second surface layer polyester raw materials are different.

Preferably, the thickness ratio of the interior polyester layer to any surface polyester layers is 1˜100:1.

The present invention also relates to a polyester film produced by the above-described production method.

The present invention further relates to a diffusion film which comprises a polyester film produced by the above-described production method.

Additionally, the present invention relates to a brightness enhancement film which comprises a polyester film produced by the above-described production method, and the step of providing the at least one polyester raw material comprises producing a light-condenser prismatic structure on the at least one polyester raw material layer.

The method for producing a multi-function polyester film according to the present invention produces a polyester film having a diffusion ability by internally adding diffusion particles, followed by the melt-extrusion. Therefore, the production method not only can save additional processing loss as compared with the conventional surface-coating of the diffusion particles, but also achieves the desired diffusion effect. Besides, the internal addition of diffusion particles can enhance the surface hardness to improve the scratch-resistance of the polyester film, whereby the process of adhering a protective film after the surface coating by the diffusion particles can be omitted.

### BRIEF DESCRIPTION OF THE DRAWING

FIG. 1 is a flow chart of the method for producing a polyester film according to the present invention.

FIG. 2 shows the apparatus used in the method for producing a polyester film according to the present invention.

The reference numerals of major components are described as below:

(a) The step of providing a polyester raw material

(b) The step of forming a polyester sheet

(c) The step of biaxial orientation

(d) Obtaining a polyester film

(1) The exterior-layer extruder

(2) The interior-layer extruder

(3) The confluent die

(4) The chilling roller

(5) The machine direction orientation zone

(6) The transverse direction orientation zone

(7) The spreading roller

(8) The chuck

(9) The polyester film

### DETAILED DESCRIPTION

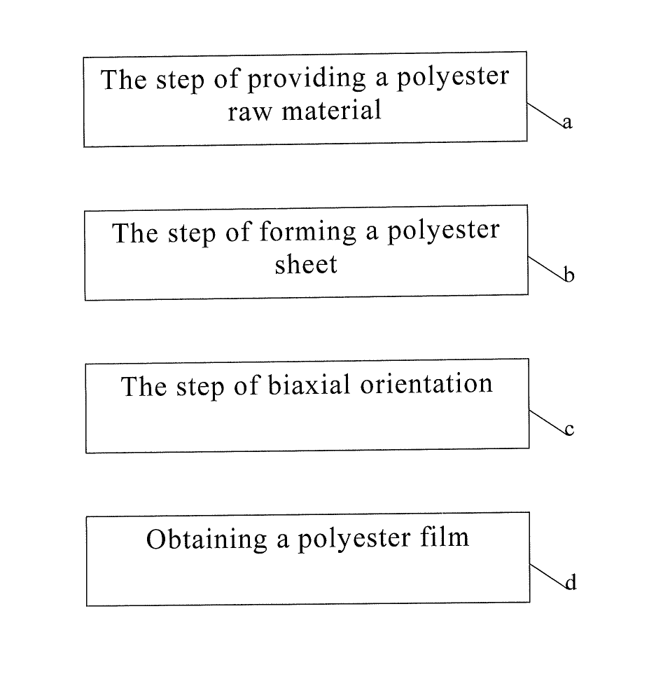

Referring to FIG. 1 is the method for producing a polyester film according to the present invention, which comprises:
(a) a step of providing a polyester raw material comprising:
   providing at least one polyester raw material which is polyethylene terephthalate) (PET), acrylic, polycarbonate, polyethylene naphthalate) (PEN) or other known polymers by a skilled person in the art, or the combinations of the above polymers, or the copolymers thereof; and
   adding organic or inorganic diffusion particles into the at least one polyester raw material, wherein the diffusion particles are selected from the group consisting of polymethyl methylacrylate (PMMA), silica, silicone, polystyrene (PS), melamine, barium sulphate, calcium carbonate, titanium oxide, zirconium oxide, aluminum oxide, silica gel and the combinations thereof, and wherein the diffusion particles can be in a spherical, a grape-like, a hollow spherical or a polygonal shape, etc.; and optionally,
   adding UV-resistant modifiers, weather-resistant modifiers, hydrolysis-resistant modifiers, heat-resistant modifiers, slippery property modifiers, crystallinity modifiers or comonomers in the polyester raw material; or
   performing any of the PET modification technologies known by a skilled person in the art;
(b) a step of forming a polyester sheet comprising:
   melt-extruding the above-described polyester raw material at a temperature between 260° C. and 300° C. and immediately cooling to 25° C. to 50° C. and then forming a polyester sheet;
(c) a step of biaxial orientation comprising:
   biaxially orientating the polyester sheet in machine direction and transverse direction and then obtaining a polyester film(s) by cool setting, wherein the total thickness of the polyester film is 20 μm˜500 μm.

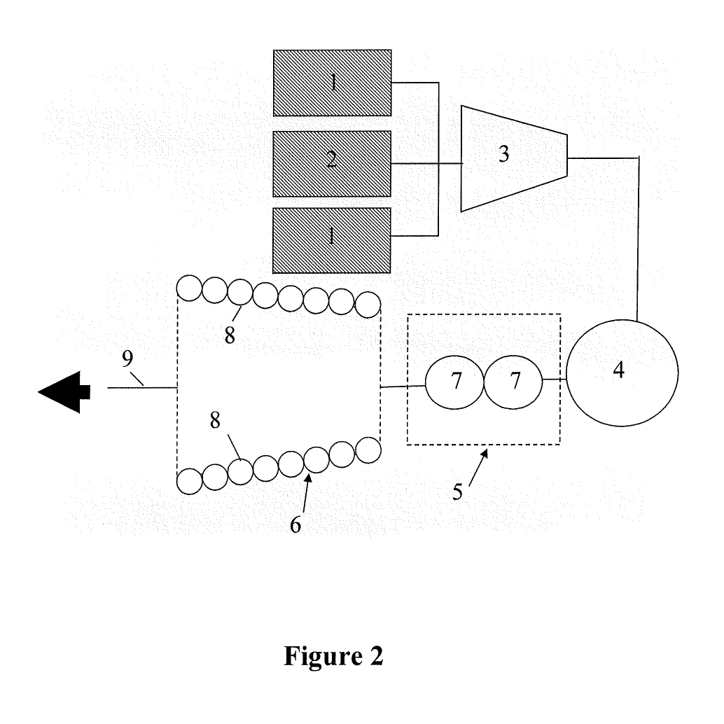

Referring to FIG. 2 is an exemplary apparatus used for carrying out the steps (b) and (c) and detail steps. The mixed raw material containing organic or inorganic particles is extruded by an exterior-layer extruder (1), whereas the mixed raw material containing different proportions of organic or inorganic particles is extruded by an interior-layer extruder (2). The molten polyester raw material is extruded and converged on a confluent die (3) to flow out, and then spread to form a sheet on a chilling roller (4) and shaped by cooling through a chilling roller. After that, the biaxial orientation of the sheet is carried out by the speed difference of a spreading roller (7) and a chuck (8) in a machine direction orientation zone (5) and a transverse direction orientation zone (6), respectively, and then a polyester film (9) is cool set by air-shower.

The polyester film according to the present invention is based on the polyester, wherein the organic or inorganic diffusion particles and other additives are added. The polyester film is produced by mixing polyester with diffusion particles and/or an additive, melt extruding the mixture, rapidly cooling it to form a polyester sheet, extending the polyester sheet in machine direction and transverse direction, followed by heat setting and cooling. However, the means of the melt extrusion can be a monolayer extrusion or a multilayer extrusion, wherein if A, B and C individually represents polyesters with various additive proportions, the possible addition manners are A type of monolayer polyester, A/B type of double layer polyester, A/B/B, A/B/A or A/B/C type of triple layer polyester and the like. Further, the present invention achieves the desired purpose by adding organic or inorganic particles into the surface layer or the interior layer of the film, and the control of the thickness of the surface layer, the selection of the types and the shapes of the particles, the effects on the sizes and the concentration of the particles all are important consideration factors of the present invention.

The full-layer polyester film product may have a thickness of 20 μm˜500 μm, wherein the ratio of the interior polyester layer (the main layer) to the surface polyester layer (the skin layer) can be 1˜100 times. The diffusion particles to be added can be selected from organic or inorganic particles. For example, the diffusion particles can be PMMA, silica, silicone, polystyrene (PS), melamine, barium sulphate, calcium carbonate, titanium oxide, zirconium oxide, aluminum oxide or silica gel, etc. The shapes of the diffusion particles can be spherical or non-spherical, wherein the spherical shape has a better diffusion effect than the non-spherical shape. In order to achieve the desired surface roughness and diffusion effect, the desired surface roughness cannot be achieved if the diffusion particles are too small whereas the transparency of the film will be severely affected if the diffusion particles are too large. Thus, the diffusion particles can have an average particle diameter of 0.1 μm˜15 μm or larger, preferably 1˜10 μm, more preferably 3˜6 μm. Further, it is one of the consideration factors whether the particle diameter distribution is the single- or multi-distribution. Besides, since the addition amounts of the diffusion particles may also severely affect the surface roughness and the transparency of the film, the addition amount of the diffusion particles is 0.01˜10 wt % of the raw material. The surface roughness requirement cannot be achieved if the addition amount is below 0.01 wt %, whereas the transparency is affected due to higher haze if said amount is higher than 10 wt %. Therefore, the preferable addition amount is 0.02˜5 wt %, more preferably 0.03˜3 wt %.

On the other hand, the specialty chemical additives can be added to increase the functionality of the film, wherein the types thereof can be UV-resistant and weather-resistant modifiers, hydrolysis-resistant modifiers, thermal-resistant modifiers, slippery property modifiers, crystallinity modifiers, comonomers and other PET modifiers known by a skilled person in the art.

The UV Accelerated Weathering Tester (QUV), the Xenon (Xe) lamp, the Highly Accelerated Temperature/Humity Stress Test (HAST), Pressure Cooker Tester(PCT), the temperature- and humidity-constant machine and the moisture-and oxygen-permeability test, etc., are used to perform the reliability tests to assess the weather resistance of a film. Further, the thermal analyzer such as the Differential Scanning calorimeter (DSC), the Thermogravimetric Analyzer (TGA) and the like is used to assess the thermal resistance property; the friction coefficient is measured to assess the slippery property; and the density is measured to compare the crystallinity. Furthermore, the analyzers such as the UV Spectrophotometer, the Fourier Transform Infrared Spectrum-Microscope (FTIR-Microscopy), the Inductively Coupled Plasma Spectrometry (ICP), the Gas Chromatography (GC), the Nuclear Magnetic Resonance Spectroscopy (NMR), etc., are used to analyze the chemical constituents and the polymerization relation of the film.

### EXAMPLES

### Example 1

A pure polyester PET was mixed with particles and then, was monolayer-extruded. The added particles were polydispersive PMMA having a particle diameter of 3 μm and the content thereof was 0.3 wt % of the polyester material. Besides, the surface roughness value (Ra) of the polyester PEF film obtained therefrom was 17 nm.

### Example 2

A polyester material containing organic or inorganic particles was dried and crystallized, and was extruded by A/B/A three layer co-extrusion using a extruder after melt at 270° C., and then was rapidly cooled to 25° C. to form a polyester sheet. After that, the sheet was treated by the steps such as the heat softening, 2˜4 folds of the extension in the machine direction, pre-heating, extension, crystallization and cooling, etc., and 3˜5 folds of the extension in the transverse direction to obtain a polyester film having the thickness of 50 μm. In such a production process, the layer A was polyester which contains inorganic SiO₂ particles having a particle diameter of 3 μm in broader dispersion (which is the so-called polydispersion and is represented as the prefix “P-”), and the content of the particles was 3 wt % of the polyester material PET whereas the content of the particles for the layer B was 100 wt % of the polyester material PET. Besides, in the case that the thickness ratio of A:B:A was 1:20:1, the polyester film with 17 nm of the surface roughness value (Ra) can be obtained.

### Example 3

The production steps were identical to Example 1 in which A/B/A three layer extrusion in the thickness ratio of 1:20:1 for A:B:A was used, except the PET polyester material of the layer A was added with polydispersive spherical PS particles having 3 μm of the average particle diameter and the content of the particles was 3 wt % of the PET polyester material. Further, the layer B was the PET polyester material containing no diffusion particles. The polyester film with 20 nm of the surface roughness value (Ra) can be obtained.

### Example 4

The production steps were identical to Example 1 in which the A/B/A three layer extrusion in the thickness ratio of 1:20:1 for A:B:A was used, except the PET polyester material of the layer A was added with polydispersive spherical PMMA particles having 3 μm of the average particle diameter and the content of the particles was 3 wt % of the PET polyester material. Further, the layer B was the PET polyester material containing no diffusion particles. The polyester film with 21 nm of the surface roughness value (Ra) can be obtained.

### Example 5

The production steps were identical to Example 1, wherein the PET polyester material for the layer A comprises organic particles whereas the layer B was 100% of the PET polyester material. Further, spherical PMMA particles having 3 μm of the average particle diameter and narrow dispersion of the particle diameter (which is the so-called monodispersion and is represented as the prefix “M-”) were selected. The content of the particles was 3 wt % of the polyester material. Also, the polyester film with 19 nm of the surface roughness value (Ra) can be obtained in the case that the thickness ratio of A:B:A was 1:20:1.

### Example 6

The production steps were identical to Example 1. The polyester film was produced by A/B/A three layer co-extrusion, wherein the layer A was a PET polyester raw material containing the polydispersive PMMA particles having a particle diameter of 3 μm in an amount of 3 wt % of the polyester raw material; and the layer B was the PET polyester raw material containing no diffusion particles. The thickness ratio of A:B:A was 1:10:1. Thus, the polyester film with 18 nm of the surface roughness value (Ra) can be obtained.

### Example 7

The production steps were identical to Example 1. The polyester film was produced by A/B/A three layer co-extrusion, wherein the layer A was a PET polyester raw material containing the polydispersive PMMA particles having a particle diameter of 3 μm in an amount of 0.3 wt % of the polyester raw material; and the layer B was the PET polyester raw material containing no diffusion particles. The thickness ratio of A:B:A was 1:10:1. Thus, the polyester film with 12 nm of the surface roughness value (Ra) can be obtained.

### Example 8

The production steps were identical to Example 1. The polyester film was produced by A/B two layer extrusion, wherein the thickness ratio of A:B was 1:10. However, the layer A was the PET polyester raw material containing the polydispersive PMMA particles having a particle diameter of 3 μm in an amount of 3 wt % of the polyester raw material; and the layer B was the PET polyester raw material containing no diffusion particles. Thus, the polyester film with 19 nm of the surface roughness value (Ra) of the layer A can be obtained.

### Example 9

The production steps were identical to Example 1. The polyester film was produced by A/B/C three layer extrusion, wherein the thickness ratio of A:B:C was 1:10:1. However, the layer A was PET polyester raw material containing the polydispersive PMMA particles having a particle diameter of 3 μm in an amount of 3 wt % of the polyester raw material; the layer B was the PET polyester raw material containing no diffusion particles; and the layer C was a polyester containing the polydispersive PMMA particles having a particle diameter of 3 μm in an amount of 0.3 wt % of the polyester raw material. Thus, the polyester film with 19 nm of the surface roughness value (Ra) of the layer A and 12 nm of the surface roughness value (Ra) of the layer C can be obtained.

### Example 10

The production steps were identical to Example 1. The polyester film was produced by A/B/A three layer extrusion, wherein the layer A was still PET polyester raw material containing the polydispersive spherical PMMA particles having a particle diameter of 6 μm in an amount of 3 wt % of the polyester raw material PET; and the layer B was the polyester raw material PET containing no diffusion particles. The thickness ratio of A/B/A was 1:20:1. Thus, the polyester film with 30 nm of the surface roughness value (Ra) can be obtained.

### Example 11

The production steps were identical to Example 1. The polyester film was produced by A/B/A three layer extrusion, wherein the thickness ratio of A:B:A was 1:20:1. However, the layer A was PET polyester raw material containing the polydispersive spherical PMMA particles having particle diameters of 3 μm and 6 μm in an amount of 1.5 wt % of the polyester raw material, respectively; and the layer B was the PET polyester raw material containing no diffusion particles. Thus, the polyester film with 28 nm of the surface roughness value (Ra) can be obtained.

### Example 12

The production steps were identical to Example 1. The polyester film was produced by A/B two layer extrusion, wherein the thickness ratio of A:B was 1:20. However, the layer A was PET polyester raw material containing the polydispersive spherical PMMA particles having particle diameters of 3 μm and 6 μm in an amount of 1.5 wt % of the polyester raw material, respectively; and the layer B was the PET polyester raw material containing no diffusion particles. Thus, the polyester film with 28 nm of the surface roughness value (Ra) can be obtained.

For the measurement of the physical data, the haze and the total light transmittance were determined using Tokyo denshoku TC-H3 Haze meter according to ASTM D-1003 standard; the brightness was determined using Minota BN7; and the Newton ring was determined by the naked eye observation.

TABLE 1
The thickness of components and the testing result of the examples

| | | The addition | | | | Surface | | |
|---|---|---|---|---|---|---|---|---|
| | The type | concentration | The | | Total light | roughness | | |
| | of | of particles | thickness | Haze | transmittance | Ra | | Newton |
| | particles | (wt %) | ratio | (%) | (%) | (nm) | Brightness | ring |
| Example 1 | 3 μm | 3 | monolayer | 18 | 85 | 17 | Δ | Δ |
| | P-PMMA | | | | | | | |
| Example 2 | 3 μm | 3 | A/B/A | 10 | 80 | 17 | Δ | Δ |
| | P—SiO2 | | 1:20:1 | | | | | |
| Example 3 | 3 μm | 3 | A/B/A | 10 | 87 | 20 | ◯ | ◯ |
| | P-PS | | 1:20:1 | | | | | |
| Example 4 | 3 μm | 3 | A/B/A | 10 | 90 | 21 | ◯ | ◯ |
| | P-PMMA | | 1:20:1 | | | | | |
| Example 5 | 3 μm | 3 | A/B/A | 8 | 90 | 19 | ◯ | Δ |
| | M- | | 1:20:1 | | | | | |
| | PMMA | | | | | | | |
| Example 6 | 3 μm | 3 | A/B/A | 15 | 90 | 18 | Δ | Δ |
| | P-PMMA | | 1:10:1 | | | | | |
| Example 7 | 3 μm | 0.3 | A/B/A | 3 | 90 | 9 | ⊚ | X |
| | P-PMMA | | 1:10:1 | | | | | |
| Example 8 | 3 μm | 3 | A/B | 8 | 90 | 19 | ⊚ | Δ |
| | P-PMMA | | 1:10 | | | (layer A) | | |
| Example 9 | 3 μm | 3 (layer A) | A/B/C | 12 | 90 | 19 | Δ | ◯ |
| | P-PMMA | 0.3 (layer C) | 1:10:1 | | | (layer A) | | |
| | | | | | | 12 | | |
| | | | | | | (layer C) | | |
| Example | 6 μm | 3 | A/B/A | 25 | 90 | 30 | X | ⊚ |
| 10 | P-PMMA | | 1:20:1 | | | | | |
| Example | 3 μm | 1.5 + | A/B/A | 12 | 90 | 28 | Δ | ⊚ |
| 11 | P-PMMA + | 1.5 | 1:20:1 | | | | | |
| | 6 μm | | | | | | | |
| | P-PMMA | | | | | | | |
| Example | 3 μm | 1.5 + | A/B | 10 | 90 | 28 | ⊚ | ⊚ |
| 12 | P-PMMA + | 1.5 | 1:20 | | | (layer A) | | |
| | 6 μm | | | | | | | |
| | P-PMMA | | | | | | | |

The symbols represent the brightness value and the appearance of Newton ring; wherein
⊚ represents the best condition;
◯ represents better condition;
Δ represents moderate condition; and
X represents the worst condition.

It can be seen from Examples 1, 2, 3 and 4 that the inorganic (SiO₂) particles have a larger effect on the drop of the total light transmittance; the use of the organic particles have better transmittance; and the type of particles also have impacts, for example, PMMA is better than PS. Due to the constant total thickness of the film, it can be seen that the addition of particles into all of layers (the monolayer) has a larger adverse effect on the drop of the total light transmittance due to a thicker particle layer, as compared with the addition of particles in the surface. Further, it can be seen from Examples 4 and 5 that the use of the particles having the narrow dispersion of particle diameter (which is the so-called monodispersion and is represented as the prefix “M-”) can achieve the better haze than the particles having the broader dispersion of particle diameter (which is the so-called polydispersion and is represented as the prefix “P-”). According to Examples 4 and 6, under the same addition amount of particles, the contribution to the surface roughness Ra value will be greater if the surface layer is thinner; and the elimination to the optical defects of the Newton ring will be greater if the Ra value is higher; and the increase of the haze likewise will be greater if the surface layer is thicker. However, the adverse effect on the brightness will be greater if the haze is higher. Furthermore, it can be seen from Examples 6 and 7 that if the addition concentration of particles is higher, the increase of the surface roughness will be greater but the effect on the increase of the haze will also be greater. Also, it can be seen from Examples 6, 8 and 9 that the addition of particles in the single surface layer is the most preferable particle addition manner and the adverse effects on the increase of the haze and the drop of the brightness value will occur as long as two surface layers are both added with the particles. Besides, it can be understood from Examples 4, 10 and 11 that for the particle diameter, the larger particle diameter will result in the higher increase of the Ra value and the haze. If particles having two different particle diameters are added, the compensative effect will occur.

It can be understood from Table 1 that the brightness value has better performance if the turbidity caused by the addition of particles is lower, particularly the addition of particles in single side by the AB manner. On the other hand, if the particles added are larger and the surface roughness Ra value of the surface is higher, the better effects on the elimination to the generation of the Newton ring will occur, particularly the addition of the particles having different particle diameters into the surface layer. Consequently, Example 12 can achieve the best brightness value and best effect on the elimination to the Newton ring.

The forging descriptions are used to illustration the present invention in detail but it is understood that these descriptions are for the illustration purpose only. However, any modifications made by those skilled in the art still belong to the scope of the invention without departing from the spirit and the scope of the invention.

1. An method for producing a polyester film, comprising:
providing at least one polyester raw material, and adding diffusion particles into the at least one polyester raw material;
melt-extruding the said raw material, followed by rapid cooling to form a polyester sheet;
biaxially orientating the polyester sheet, and then cooling it to form a polyester film.

2. The method of claim 1, wherein the polyester film has a total thickness of 20 μm˜500 μm, a surface roughness value (Ra) above 0.1 nm, a haze value below 95%, and a transmittance above 60%.

3. The method of claim 1, wherein in the step of providing at least one polyester raw material, the polyester raw material is selected from the group consisting of poly(ethylene terephthalate) (PET), acrylic, polycarbonate, poly(ethylene naphthalate) (PEN) and the combinations and the copolymers thereof.

4. The method of claim 1, wherein in the step of providing at least one polyester raw material, the diffusion particles are added at least to the external surface of the polyester.

5. The method of claim 1, wherein in the step of melt-extruding the polyester raw material, the polyester raw material is melt-extruded at a temperature between 260° C. and 300° C. and then rapidly cooled to 25° C. to 50° C.

6. The method of claim 1, wherein the diffusion particles are selected from the group consisting of polymethyl methylacrylate (PMMA), silica, silicone, polystyrene (PS), melamine, barium sulphate, calcium carbonate, titanium oxide, zirconium oxide, aluminum oxide, silica gel and the combinations thereof.

7. The method of claim 6, wherein the diffusion particles have an average particle diameter of about 0.1 μm˜15 μm.

8. The method of claim 6, wherein the diffusion particles are added in an amount of 0.01˜10 wt % based on the content of the polyester raw material.

9. The method of claim 6, wherein the diffusion particles are in a spherical, a grape-like, a hollow spherical or a polygonal shape.

10. The method of claim 1, wherein the step of providing at least one polyester raw material further comprises the addition of an additive selected from the group consisting of UV-resistant modifiers, weather-resistant modifiers, hydrolysis-resistant modifiers, heat-resistant modifiers, slippery property modifiers, crystallinity modifiers, comonomers and the combinations thereof.

11. The method of claim 1, wherein the step of providing at least one polyester raw material comprises providing a single polyester raw material which is monolayer melt-extruded to form a single polyester film.

12. The method of claim 1, wherein the step of providing at least one polyester raw material comprises providing first and second polyester raw materials which are double-layer melt-extruded to form a double layer polyester film comprising first and second polyester layers, wherein the thickness ratio of the double-layer polyester film is 1˜100:1.

13. The method of claim 1, wherein the step of providing at least one polyester raw material comprises providing first surface layer polyester raw material, interior layer polyester raw material and second surface layer polyester raw material which are multilayer melt-extruded to form a multilayer polyester film comprising first and second surface polyester layers and an interior polyester layer formed between the said first and second surface polyester layers, wherein the thickness ratio of the interior polyester layer to any of the surface polyester layers is 1˜100:1.

14. The method of claim 13, wherein the composition of the first surface layer polyester raw material is identical to that of the second surface layer polyester raw material and different from that of the interior layer polyester raw material.

15. The method of claim 13, wherein the composition of the first surface layer polyester raw material is identical to that of the interior layer polyester raw material and different from that of the second surface layer polyester raw material.

16. The method of claim 13, wherein the compositions of the first surface layer, interior layer and second surface layer polyester raw materials are different.

17. A polyester film, produced by the method of claim 1.

18. A diffusion film, comprising the polyester film produced by the method of claim

19. A brightness enhancement film, comprises the polyester film produced by the method of claim 1 in which the step of providing at least one polyester raw material comprises producing a light-condenser prismatic structure on the at least one polyester raw material layer.

20. A lampshade with light diffusion function, comprising the polyester film produced by the method of claim 1.
